(19) United States
(12) Patent Application Publication
(10) Pub. No.: US 2002/0117554 A1
(43) Pub. Date: Aug. 29, 2002

(54) Fountain device with a rotating revolver

(76) Inventor: Chung-Kuei Lin, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/794,497

(22) Filed: Feb. 28, 2001

(51) Int. Cl. B05B 17/08

(52) U.S. Cl. 239/17; 239/222.11; 239/222.13; 239/382; 239/237; 239/225.1; 239/204; 239/263

(57) ABSTRACT

A fountain device with a rotating revolver consists of a reservoir, a water supply system, at least one bearing system, and at least one revolver. The water supply system is secured in the reservoir and pumps water to rotate the revolver and to spurt the water from a top of the revolver. The mounted revolver(s) are rotated by hydraulic power, and can selectively rotate the demanded revolver by setting a bifurcating box and the bearing system between a bottom board of the demanded revolver and a revolver below the demanded layer. The structure of this invention enables it to be used indoors, outdoors, or even on a table.

### BACKGROUND OF THE INVENTION

1. Field of the Invention

The present invention relates to a fountain device with a rotating revolver, especially a multi-layer revolver fountain device that can be established either outdoors or indoors, and even on a table.

2. Description of Related Art

A fountain is ordinarily constructed in the garden as an attractive part of beautiful scenery, but recently small indoor fountain sets have become popular, especially in artificial landscapes. A conventional fountain always uses a water pump to send water to a nozzle continuously, and then water spurts from the nozzle to form a water screen. Such a kind of fountain is monotonous because it has only one style of ejaculation, and is not proper to be set indoors because of spraying water.

Another conventional fountain is electrically controlled and has a circuit board inside the fountain, with which variations of the fountain are controlled. However, the structure and the installation of such a kind of electronic control fountain is very complex. Therefore the cost of producing of this electronically controlled fountain is high, and professionals are needed to repair this fountain.

To overcome the shortcomings, the present invention tends to provide a fountain device with a rotating revolver that has a simple structure and a lot of variations in appearance.

### SUMMARY OF THE INVENTION

The main objective of the invention is to provide a fountain device with a rotating revolver that can be placed outdoors, indoors, and even on a table.

Another objective of the invention is to provide a fountain device with a rotating revolver that has a lot of variations in appearance.

Still another objective of the invention is to provide a fountain device with a rotating revolver that has a simple structure and is easily repaired.

Other objects, advantages and novel features of the invention will become more apparent from the following detailed description when taken in conjunction with the accompanying drawings.

### BRIEF DESCRIPTION OF THE DRAWINGS

FIG. 1 a cross-sectional side view of a fountain device with a rotating revolver;

FIG. 2 is a cross-sectional side view of a first embodiment of the fountain device with a rotating revolver;

FIG. 3 is a cross-sectional side view of a second embodiment of the fountain device with a rotating revolver for indoor use that has two layers, and a rotating bottom layer;

FIG. 4 is a cross-sectional side view of a third embodiment of the fountain device with a rotating revolver for outdoor use that has two layers, and a rotating bottom layer;

FIG. 5 is a cross-sectional side view of a first embodiment of the fountain device with a rotating revolver for indoor use that has two rotating layers; and

FIG. 6 is a cross-sectional side view of a first embodiment of the fountain device with a rotating revolver for outdoor use that has two rotating layers.

### DETAILED DESCRIPTION OF PREFERRED EMBODIMENT

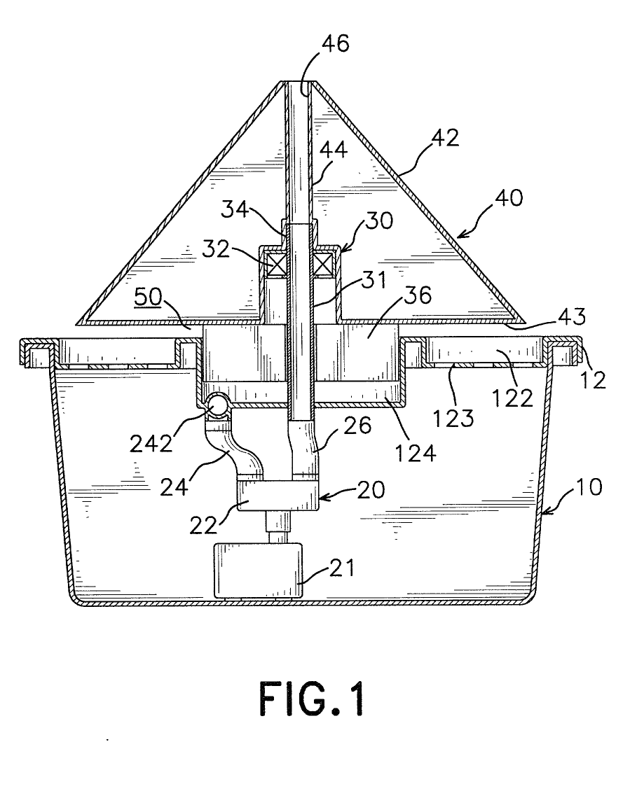

With reference to FIG. 1, a fountain device with a rotating revolver consists of a reservoir (10), a water supply system (20), a bearing system (30), and a revolver (40).

The reservoir (10) is a base of the fountain device, and a covering plate (12) is mounted on the reservoir (10) and partly received inside the reservoir (10). Said covering plate (12) has a round reservoir (124) is defined in a center of the covering plate (12) and a sink (122) defined therein around the round reservoir (124). Multiple holes (123) are defined in the sink (122) to communicate with the reservoir (10)

The water supply system (20) is composed of a water pump (21), a bifurcating box (22) connected with the water pump (21), a first passage (24) and a second passage (26) respectively extended from the bifurcating box (22), and a nozzle (242) secured at a distal end of the first passage (24).

The bearing system (30) is composed of an axle tube (31), a bearing (32) assembled around the axle tube (31), and a bearing sleeve (34) mounted on a top of the combined bearing (32) and axle tube (31). A plurality of radial plates (36) are formed around the axle (31) and partly received in the round reservoir (124). The bearing (32) diminish a friction of the rotating revolver (40). The revolver (40) pivotally mounted on the bearing system (30) is a tapered body that is hollow and composed of a shell (42) and a bottom board (43). A gap (50) is defined between the bottom board (43) and the covering plate (12). A tube (44) is vertically secured in the middle of the revolver (40) and communicates with the air via a spurt opening (46) defined at an apex f the revolver (40). The tube (44) penetrates the bearing system (30) and extends out of the revolver (40) to connect with the second passage (26) of the bifurcation box (22).

When the fountain device with a rotating revolver operates, water stored in the reservoir (10) is pumped to the bifurcating box (22) by the water pump (21) and divided into two streams in the bifurcating box (22) to the first passage (24) and the second passage (26). Then the water in the first passage (24) is spurted out via the nozzle (242) in the round reservoir (124) to cause a whirlpool to rotate the bearing (32), so that the revolver (40) mounted on the bearing system (30) rotates simultaneously with the bearing (32). Water in the second passage (26) is pumped up along the axle tube (31) to the tube (44) and spread out from the spurt opening (46). Spurted water flows downwardly along the shell (42) of the revolver (40) and falls into the sink (122) of the covering plate (12), and then returns to the reservoir (10) via multiple holes (123) defined in a bottom of the sink (122).

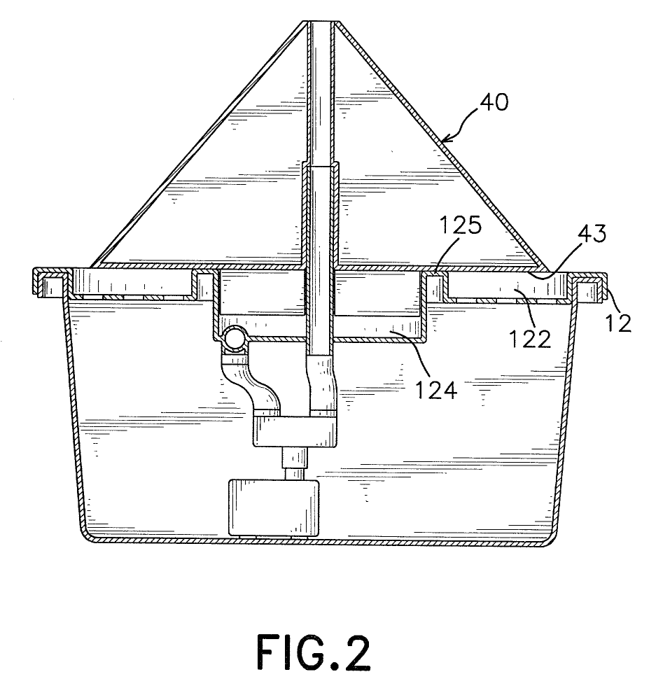

FIG. 2 is another preferred embodiment, wherein a bridge (125) between the sink (122) and the round reservoir (124) of the covering plate (12) is smoothly contacted with the bottom board (43) of the revolver (40) to keep dust or particles from entering the round reservoir (124) to otherwise pollute the water. Because water exits between the engagement between the bridge (125) and the bottom board (43), the water provides lubrication to the friction of the bottom board (43) to the bridge (125). Therefore, the friction of the bottom board (43) to the bridge (125) is low and a need for the bearing (32) with the bearing sleeve (34) of the first embodiment is eliminated.

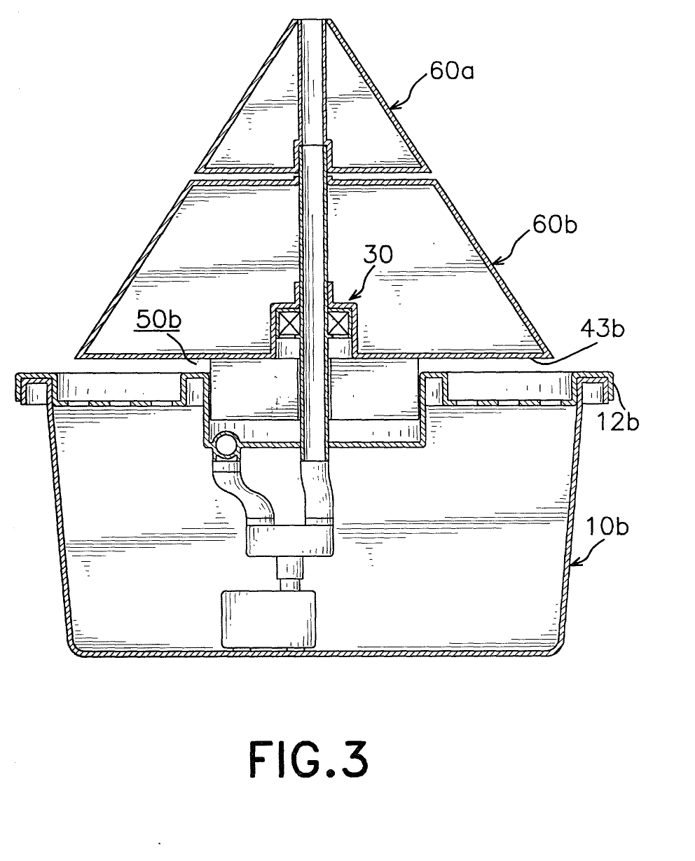

FIG. 3 is another preferred embodiment of this fountain device, wherein a first revolver (60a) is mounted on a second revolver (60b) which is mounted on the reservoir (10b), and only the second revolver (60b) rotates with the bearing system (30) being secured under the second revolver (60b). The gap (50b) is defined between the bottom board (43b) of the second revolver (60b) and the covering plate (12b).

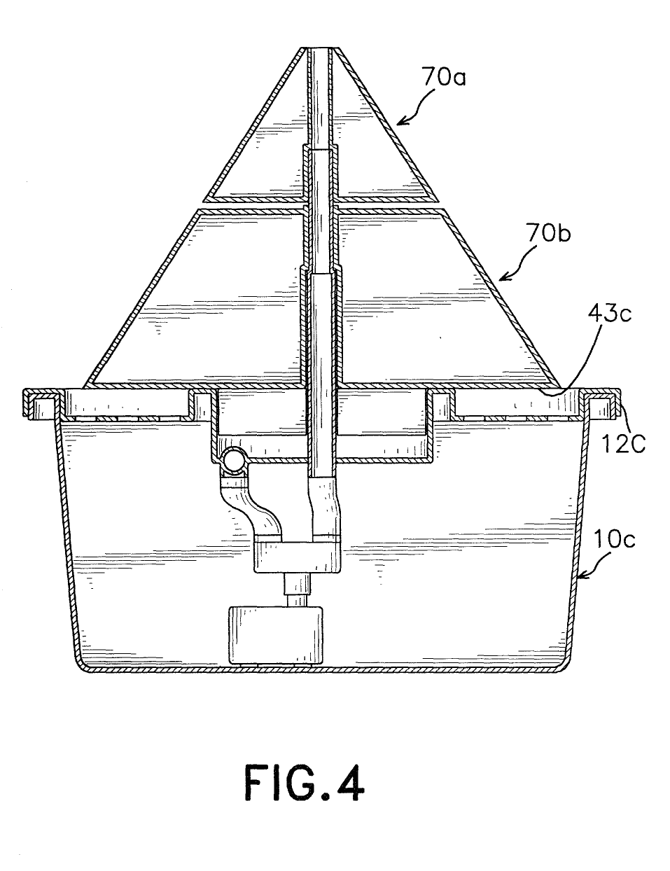

FIG. 4 is still another preferred embodiment of this fountain device, wherein a first revolver (70a) is mounted on a second revolver (70b) which is mounted on the reservoir (10c), and the only the second revolver (70b) rotates. The bottom board (43c) and the covering board (12c) are partly connected with each other smoothly. Due to the similarity in structure of FIG. 4 to FIG. 2, the same elements will be designated to have the same reference numeral and detailed description thereof is omitted.

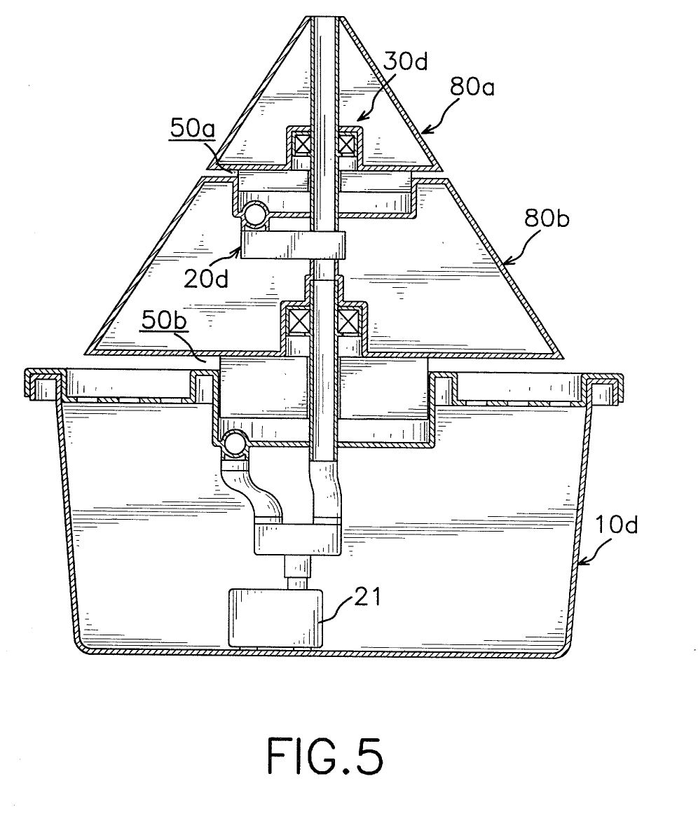

FIG. 5 is still another preferred embodiment of this fountain device, wherein a first revolver (80a) is mounted on a second revolver (80b), and the second revolver (80b) is mounted on the reservoir (10d), and both layers rotate. A gap (50a) is defined between the first revolver (80a) and the second revolver (80b), and another gap (50b) is defined between the second revolver (80b) and the reservoir (10d). In order to have the first revolver (80a) to rotate independently to the second revolver (80b), a secondary bearing system (30d) and a secondary water system (20d) are provided to the first revolver (80a) the same as those described earlier.

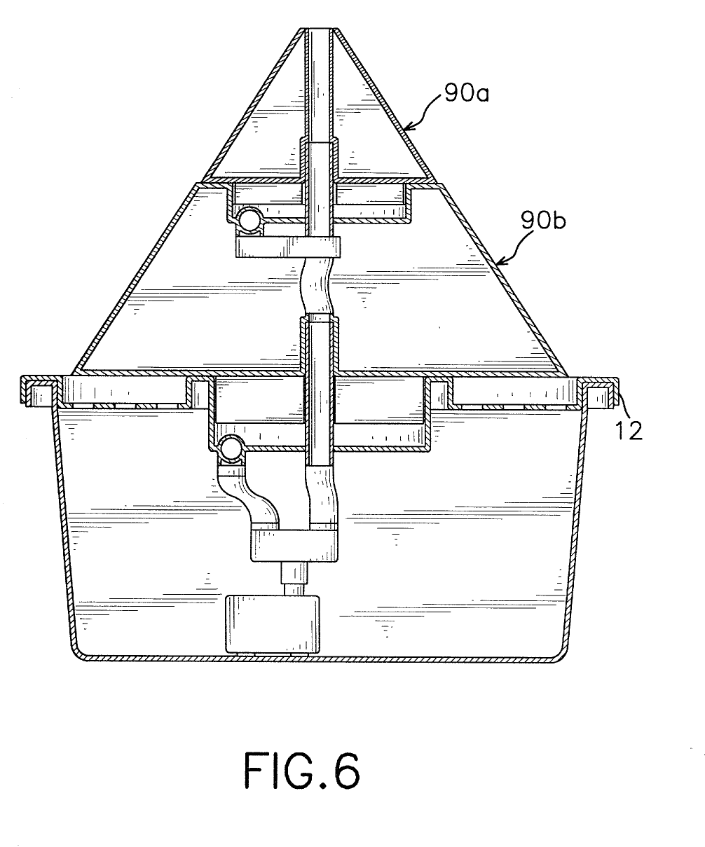

FIG. 6 is another preferred embodiment of this fountain device, wherein a first revolver (90a) is mounted on a second revolver (90b), and both revolvers (90a,b) rotate. The principles of rotating the first revolver (90a) is the same with that of the embodiment in FIG. 5, but interfaces of the first revolver (90a), the second revolver (90b) and the covering plate (12) are smoothly contacted. Therefore, lubrication of the existing water makes the need for the bearing (32) with the bearing sleeve (34) of the first embodiment is eliminated.

It is to be understood that many characters of the present invention have been set forth in the foregoing description together with details of the structure and function of the invention. However, the disclosure is illustrative only and changes may be made in detail, especially in matters of shape, size, and arrangement of parts within the principles of the invention to the full extent indicated by the broad general meaning of the terms in which the appended claims are expressed.

What is claimed is:

1.A fountain device with a rotating revolver comprising:
at least one revolver;
a reservoir being a base of the revolver;
a covering plate mountable on the reservoir, said covering plate having a round reservoir defined in a center of the covering plate, a sink defined around the round reservoir, and multiple holes defined in a bottom face of the sink to communicate with the reservoir; and
at least one bearing system having an axle tube and a plurality of radial plates, said axle tube penetrating the covering plate and communicating with the water supply system in the reservoir and said plurality of radial plates are received in the round reservoir of the covering plate; and
a water supply system secured in the reservoir, said water supply system comprising a water pump to pump water to rotate the plates in the round reservoir;

2. The fountain device with a rotating revolver as claimed in claim 1, wherein the water supply system has a first bifurcating box in the reservoir, said the first bifurcating box divides a supply water into a first passage and a second passage, said first passage has a nozzle secured in the round reservoir of the covering plate to spurt water on the radial plates inside the reservoir to rotate the revolver, and said second passage is connected to the axle tube to spurt water from a spurt opening of the revolver.

3. The fountain device with a rotating revolver as claimed in claim 1, wherein the at least one revolver is replaced by a first revolver and a second revolver, said first revolver is mounted on the second revolver, and the second revolver is mounted on the reservoir.

4. The fountain device with a rotating revolver as claimed in claim 2, wherein the at least one revolver is replaced by a first revolver and a second revolver, said first revolver is mounted on the second revolver, and the second revolver is mounted on the reservoir.

5. The fountain device with a rotating revolver as claimed in claim 3, there is a second bifurcating box secured between the first revolver and the second revolver, said second bifurcating box divides a supply water into different streams and one stream of water pushes the radial plates to rotate the first revolver.

6. The fountain device with a rotating revolver as claimed in claim 4, wherein a second bifurcating box is secured between of the first revolver and the second revolver, said second bifurcating box divides a supply water into different streams and one stream of water pushes the radial plates to rotate the first revolver.

7. The fountain device with a rotating revolver as claimed in claim 1, wherein the bearing system consists of a bearing fixed on the axle tube and a bearing sleeve mounted on the bearing, the at least one bearing system is sandwiched between the revolver and the reservoir to diminish friction of the revolver.

8. The fountain device with a rotating revolver as claimed in claim 2, wherein the bearing system consists of a bearing fixed on the axle tube and a bearing sleeve mounted on the bearing to diminish friction of the revolver.

9. The fountain device with a rotating revolver as claimed in claim 3, wherein a first bearing system sandwiched between the first revolver and the second revolver, a second bearing system sandwiched between the second revolver and the reservoir, both bearing system consist of a bearing fixed on the axle tube and a bearing sleeve mounted on the bearing to diminish friction of the first revolver/second revolver.

10. The fountain device with a rotating revolver as claimed in claim 4, wherein a first bearing system sandwiched between the first revolver and the second revolver, a second bearing system sandwiched between the second revolver and the reservoir, both bearing system consist of a bearing fixed on the axle tube and a bearing sleeve mounted on the bearing to diminish friction of the first revolver/second revolver.

11. The fountain device with a rotating revolver as claimed in claim 5, wherein a first bearing system sandwiched between the first revolver and the second revolver, a second bearing system sandwiched between the second revolver and the reservoir, both bearing system consist of a bearing fixed on the axle tube and a bearing sleeve mounted on the bearing to diminish friction of the first revolver/second revolver.

12. The fountain device with a rotating revolver as claimed in claim 6, wherein a first bearing system sandwiched between the first revolver and the second revolver, a second bearing system sandwiched between the second revolver and the reservoir, both bearing system consist of a bearing fixed on the axle tube and a bearing sleeve mounted on the bearing to diminish friction of the first revolver/second revolver.
